(19) United States
(12) Patent Application Publication
(10) Pub. No.: US 2006/0002371 A1
(43) Pub. Date: Jan. 5, 2006

(54) Roaming communication system over Internet with remote hosts and related method

(76) Inventor: Heng-Chien CHEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,366

(22) Filed: Jul. 5, 2004

(51) Int. Cl. H04L 12/28

(52) U.S. Cl. 370/352

(57) ABSTRACT

A method of routing data between IP-based telephone extensions in a telecommunications network. A remote host connected to a first remote telephone group connects with a main host through the Internet. A source IP-based telephone in the first remote telephone group generates data packets with for contacting a destination IP-based telephone in the second remote telephone group and transmits the data packets to the remote host. The remote host transmits the data packets to the main host, and the main host transmits the data packets to the destination IP-based telephone in the second remote telephone group for establishing communication between the source IP-based telephone in the first remote telephone group and the destination IP-based telephone in the second remote telephone group.

### BACKGROUND OF INVENTION

1. Field of the Invention

The present invention relates to a telephone communication system, and more specifically, to a roaming telephone communication system created across the Internet using remote hosts for controlling and regulating remote telephone systems.

2. Description of the Prior Art

With the popularity of Internet connections, Voice over Internet Protocol (VoIP) communication systems have been developed to transmit voice efficiently over the Internet. In the prior art, each terminal in VoIP systems connects to the Internet through a physical IP address, which is provided by an Internet Service Provider (ISP). However, voice packets are transmitted through the physical IP addresses in peer-to-peer way, which lacks flexibility of network mechanism to transmit voice packets through the Internet.

VoIP systems such as Internet protocol private branch exchange (IP PBX) systems allow users to use IP phones to make VoIP phone calls to other IP phones or to phones on a public switched telephone network (PSTN).

Please refer to FIG. 1. FIG. 1 is a block diagram of an IP PBX communications system 10 according to the prior art. The IP PBX communications system 10 contains a plurality of remote telephone networks connected together through the Internet 12. Each of the remote phone networks is connected to the Internet 12 through a virtual private network (VPN) or though a high speed Internet connection. For example, the IP PBX communications system 10 of FIG. 1 illustrates several VPNs 14, 18, 32, 38, 44, and 50 connected to the Internet 12. Voice gateways are used for connecting analog phones, PBX systems, or KTS systems to the IP PBX communications system 10.

A host 20 is connected to the VPN 18 for controlling operation of the IP PBX communications system 10. A hub 22 is connected to the host 20 for connecting a plurality of Internet devices to the host 20. For instance, several local IP phones 24 are connected to the hub 22. The local IP phones 24 are labeled as being “local” because they are connected to the same network as the host 20. In addition, a voice gateway 26 is connected to the hub 22 for connecting analog phones 30 and a PBX/KTS system 28 to the IP PBX communications system 10.

Analog phones 36 are connected to the IP PBX communications system 10 through voice gateway 34 and VPN 32. Similarly, PBX 42 is connected to the IP PBX communications system 10 through voice gateway 40 and VPN 38. The prior art system also connects multiple voice gateways to a single VPN. For instance, a plurality of analog phones 48 are connected to the IP PBX communications system 10 through respective voice gateways 46, each of the voice gateways 46 being connected to the single VPN 44. If only IP phones are to be remotely connected to the IP PBX communications system 10, then a voice gateway is not necessary. For example, a single remote IP phone 52 is connected through the VPN 50. If multiple remote IP phones were to be used instead of the single remote IP phone 52, then a hub could be used to connect each of the remote IP phones to the VPN 50. The remote IP phone 52 is called “remote” since it is not connected to the Internet 12 through the same local network as the host 20.

A gatekeeper 16 is connected to the IP PBX communications system 10 through the VPN 14 for acting as an agent to the host 20. The gatekeeper 16 performs IP address translation services for enabling all of the voice gateways to call each other. Therefore, the gatekeeper 16 changes the connections between the voice gateways from peer to peer connections to multipoint to multipoint connections.

Unfortunately, the prior art IP PBX communications system 10 has many disadvantages. First of all, many physical IP addresses are consumed. Each of the IP phones 24 and 52 and each of the voice gateways 26, 34, and 46 requires a unique IP address. Of course, the VPNs 14, 18, 32, 38, 44, and 50 each require an IP address as well. When only one voice gateway is connected to a VPN, the voice gateway can use the same IP address that is provided to the VPN. This is the case for the voice gateway 34 and the VPN 32, for example. However, the three voice gateways 46 will each require a separate IP address, meaning that the VPN 44 must be supplied with at least three physical IP addresses. Moreover, for each analog phone, PBX system, or KTS system connected to a voice gateway, a foreign exchange station (FSX) port is required. Therefore, the voice gateways 26 and 34 need to be equipped with 3 FXS ports and 2 FXS ports, respectively.

In addition to the physical resources required by the prior art IP PBX communications system 10, setting up the numerous voice gateways, and VPNs is very complicated, and requires significant time and knowledge of telecommunication equipment.

Please refer to FIG. 2. FIG. 2 is a block diagram of a roaming communication system 100 for communicating over the Internet according to the prior art. A main host 114 is connected to the Internet 110 through an Internet connection 112. The Internet connection 112 is usually an xDSL connection or another suitable broadband Internet connection. Because of the importance of the main host 114 to the roaming communication system 100, the Internet connection 112 provided to the main host 114 provides a static IP address. The main host 114 controls operation of the roaming communication system 100. A hub 116 is connected to the main host 114 for connecting an access point 120 and a plurality of local IP phones 118 to the roaming communication system 100. Each of the local IP phones 118 can be used for making VoIP phone calls. The access point 120 is used for connecting a plurality of wireless local IP phones 122 to the hub 116 wirelessly. The local IP phones 118 and the wireless local IP phones 122 are referred to as “local” because they are connected to the Internet 110 through the same Internet connection 112 as the main host 114.

In addition, the roaming communication system 100 also contains two remote telephone networks. Internet connections 130 and 140 each provide dynamic IP addresses, although static IP addresses may also be used. IP sharing devices 132 and 142 are respectively connected to the Internet connections 130 and 140. An access point 134 is connected to the IP sharing device 132 for providing Internet access to a plurality of wireless roaming IP phones 136. A hub 144 is connected to the IP sharing device 142 for allowing multiple devices to share the Internet connection 140. A roaming IP phone 146 is connected to the hub 144 and a plurality of wireless roaming IP phones 150 are connected to the hub 144 via a wireless connection to an access point 148. The roaming IP phone 146 and the wireless roaming IP phones 150 are labeled as “roaming” because they are not connected to the Internet 110 through the same Internet connection as the main host 114. In addition, a data access arrangement (DAA) module 152 is connected to the hub 144 for connecting a PSTN 154 to the roaming communication system 100.

In order for any of the phones in the roaming communication system 100 to make a VoIP telephone call, the main host 114 needs to be contacted for establishing a connection between the source phone and the destination phone.

The roaming communication system 100 requires less physical IP addresses than the IP PBX communications system 10 since the IP phones can share connections to single IP addresses. However, the prior art roaming communication system 100 also has a few disadvantages. First of all, if the main host 114 becomes disconnected from the rest of the roaming communication system 100, the roaming communication system 100 is paralyzed. For example, if the Internet connection 112 experiences an outage, the main host 114 is not able to establish a VoIP phone call through the Internet 110. Likewise, if any remote group loses its Internet connection, then that remote group cannot be used for making VoIP phone calls. In addition, whenever the main host 114 sends data or messages to all of the IP phones or other telecommunications devices in the roaming communication system 100, the main host 114 sends data packets to each individual device. This sudden surge of data being sent along through the various Internet connections can cause a bottleneck of Internet traffic, and cause disruptions in the Internet connections.

### SUMMARY OF INVENTION

It is therefore an objective of the claimed invention to provide a method of routing data between telephone extensions in a roaming communication system created over the Internet utilizing a remote host in order to solve the above-mentioned problems.

According to the claimed invention, a method of routing data between IP-based telephone extensions in a telecommunications network is proposed. The telecommunications network includes a first Internet Protocol (IP) sharing device for sharing connection to a first IP address and a first remote telephone group containing a first set of IP-based telephones. The first remote telephone group is connected to the Internet through the first IP sharing device, and each of the IP-based telephones in the first remote telephone groups is assigned a unique identifier. The telecommunications network also includes a second IP sharing device for sharing connection to a second IP address and a second remote telephone group containing a second set of IP-based telephones. The second remote telephone group is connected to the Internet through the second IP sharing device, and each of the IP-based telephones in the second remote telephone groups is assigned a unique identifier. A main host is connected to the Internet for controlling data traffic over the Internet between the first remote telephone group and the second remote telephone group, and a remote host is connected to the Internet through the first IP sharing device for linking the first remote telephone group to the second remote telephone group and main host. The claimed invention method includes the remote host connecting with and logging into the main host, generating data packets with a source IP-based telephone in the first remote telephone group for contacting a destination IP-based telephone in the second remote telephone group, transmitting the data packets to the remote host, the remote host transmitting the data packets to the main host, and the main host transmitting the data packets to the destination IP-based telephone in the second remote telephone group for establishing communication between the source IP-based telephone in the first remote telephone group and the destination IP-based telephone in the second remote telephone group.

According to another embodiment of the claimed invention, another method of routing data between IP-based telephone extensions in a telecommunications network is proposed. The telecommunications network includes a first IP sharing device for sharing connection to a first IP address and a first remote telephone group containing a first set of IP-based telephones. The first remote telephone group is connected to the Internet through the first IP sharing device, and each of the IP-based telephones in the first remote telephone groups is assigned a unique identifier. The telecommunications network also includes a second IP sharing device for sharing connection to a second IP address and a second remote telephone group containing a second set of IP-based telephones. The second remote telephone group is connected to the Internet through the second IP sharing device, and each of the IP-based telephones in the second remote telephone groups is assigned a unique identifier. A main host is connected to the Internet for controlling data traffic over the Internet between the first remote telephone group and the second remote telephone group, a first remote host is connected to the Internet through the first IP sharing device for linking the first remote telephone group to the second remote telephone group and main host, and a second remote host is connected to the Internet through the second IP sharing device for linking the second remote telephone group to the first remote telephone group and main host. The claimed invention method includes the first and second remote hosts connecting with and logging into the main host, generating data packets with a source IP-based telephone in the first remote telephone group for contacting a destination IP-based telephone in the second remote telephone group, transmitting the data packets to the first remote host, the first remote host transmitting the data packets to the second remote host, and the second remote host transmitting the data packets to the destination IP-based telephone in the second remote telephone group for establishing communication between the source IP-based telephone in the first remote telephone group and the destination IP-based telephone in the second remote telephone group.

It is an advantage of the claimed invention that the remote host acts as a group executioner for commands given by the main host. If the main host needs to send data or messages to all of the IP-based telephones in the telecommunications network, the main host only has to send the data or messages to the remote host. The remote host will then send a copy of the data or messages to each of the IP-based telephones in the same group as the remote host. It is another advantage of the claimed invention that the remote host can act as a host for the corresponding group of IP-based telephones if the group ever becomes disconnected from the main host. In this way, the IP-based telephones can still be used to send calls locally within the group when the main host cannot be contacted.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of an IP PBX communications system according to the prior art.

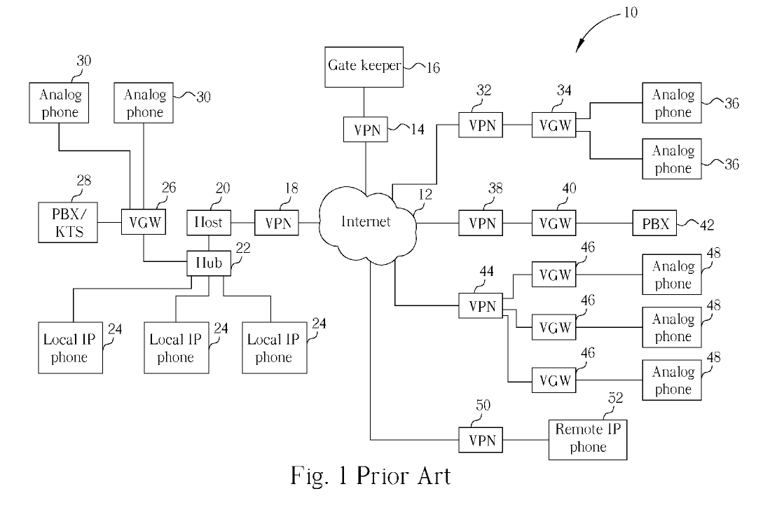

FIG. 2 is a block diagram of a roaming communication system for communicating over the Internet according to the prior art.

FIG. 3 is a block diagram of a roaming communication system with a remote host according to the present invention.

FIG. 4 is a simplified block diagram of a roaming communication system with remote hosts according to the present invention.

FIG. 5 is a message sequence diagram showing communication in the roaming communication system before insertion of group A and group B remote hosts.

FIG. 6 is a message sequence diagram showing initialization of the roaming communication system after insertion of the group A and group B remote hosts.

FIG. 7 is a message sequence diagram showing communication in the roaming communication system after initialization.

FIG. 8 is a message sequence diagram showing communication in the roaming communication system after the main host is disconnected from the group A and group B remote hosts.

### DETAILED DESCRIPTION

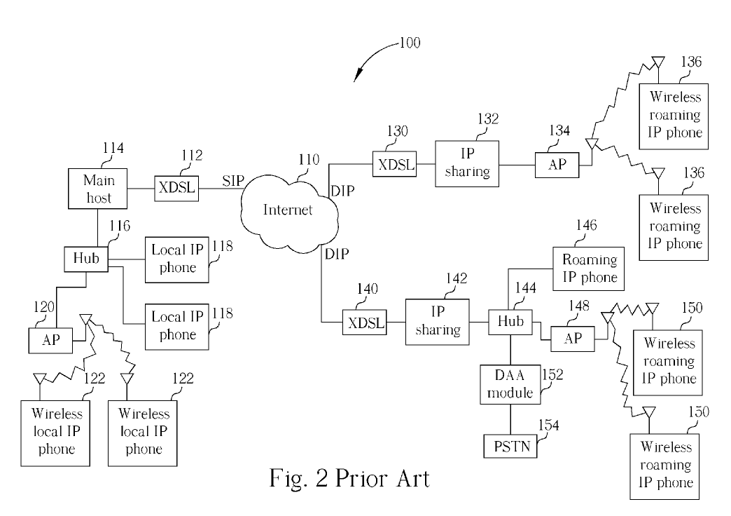

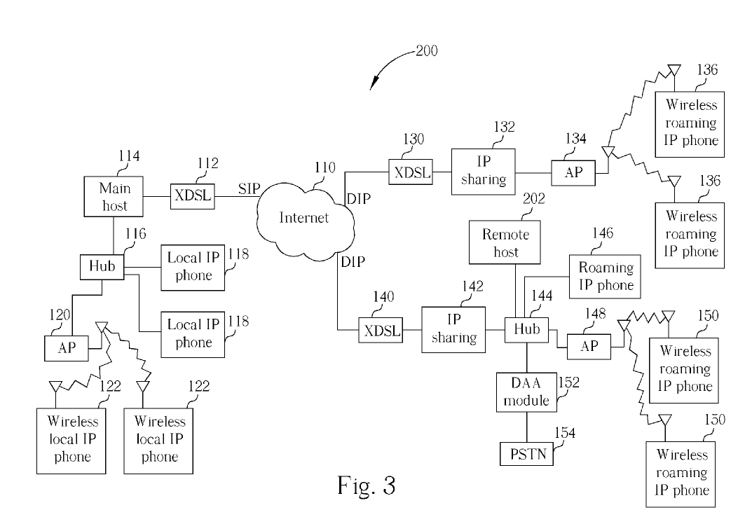

Please refer to FIG. 3. FIG. 3 is a block diagram of a roaming communication system 200 with a remote host 202 according to the present invention. The roaming communication system 200 is identical to the roaming communication system 100 shown in FIG. 2 except for the addition of the remote host 202. All other devices shown in FIG. 3 have already been explained above with respect to the description of FIG. 2 and will not be explained again for brevity. The remote host 202 is connected to the hub 144 for operating as a local agent of the main host 114. The remote host 202 controls the data and messages sent to and from devices connected to the Internet 110 through the Internet connection 140. Although not shown in FIG. 3, another remote host could also be used with the group of devices connected to the Internet 110 through the Internet connection 130.

The remote host 202 does not require an additional IP address, and can share the dynamic IP address that is provided by the Internet connection 140. The remote host 202 acts as a group executioner for the group of devices connected to the Internet 110 through the Internet connection 140 whether the remote host 202 is connected to the main host 114 or not. When the remote host 202 is connected to the main host 114, the remote host 202 acts as an intermediary between the main host 114 and the IP phones in the same local group as the remote host 202. When the remote host 202 becomes disconnected from the main host 114, the remote host 202 can still act as a mini-host for the local group to give the local group the functions of a local PBX/KTS system and a local area network (LAN). In this way, the IP phones 146 and 150 in the local group can still make phone calls to each other and to other phones in the PSTN 154 because the remote host 202 will establish connection for these phone calls.

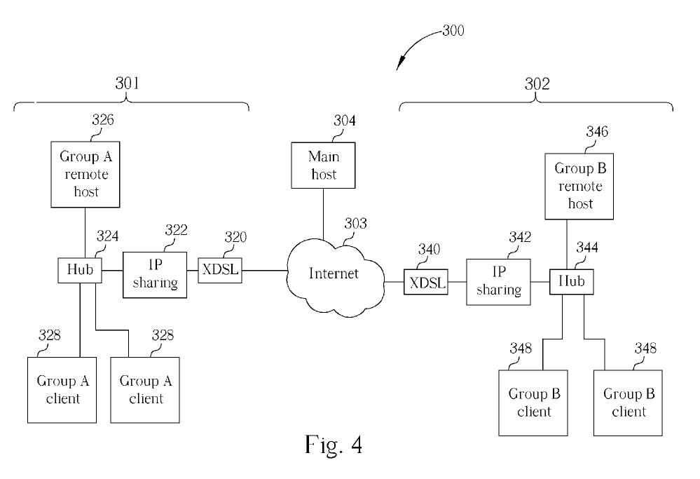

Please refer to FIG. 4. FIG. 4 is a simplified block diagram of a roaming communication system 300 with remote hosts according to the present invention. The roaming communication system 300 is divided into group A 301, group B 302, and a main host 304, each of which is connected to the Internet 303. Group A 301 contains an Internet connection 320 for providing a dynamic or static IP address that is shared by other devices through an IP sharing device 322. A hub 324 is connected to the IP sharing device 322 for sharing the Internet connection 320 with a group A remote host 326 and a plurality of group A clients 328. Similarly, group B 302 contains an Internet connection 340 for providing a dynamic or static IP address that is shared by other devices through an IP sharing device 342. A hub 344 is connected to the IP sharing device 342 for sharing the Internet connection 340 with a group B remote host 346 and a plurality of group B clients 348.

The following will describe the operation of the roaming communication system 300, and how the group A remote host 326 and the group B remote host 346 affect the communication between the group A and group B clients 328 and 348. Specific examples will be given of data and messages exchanged between the various components of the roaming communication system 300.

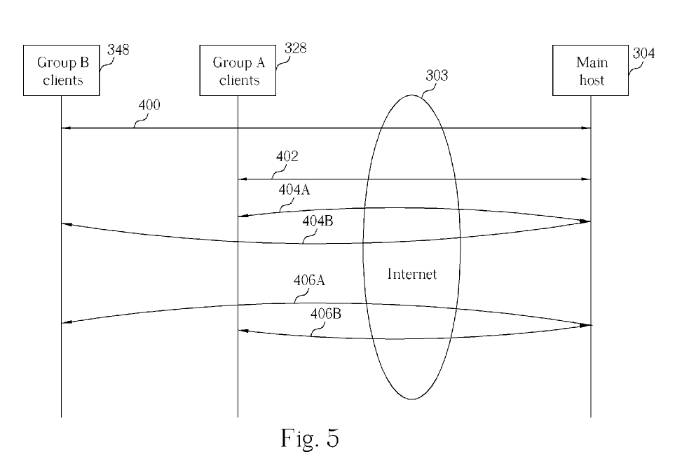

Please refer to FIG. 5. FIG. 5 is a message sequence diagram showing communication in the roaming communication system 300 before insertion of the group A and group B remote hosts 326 and 346. The message sequence diagram illustrates a series of events representing messages exchanged between the components of the roaming communication system 300. Time is represented in a vertical direction of the message sequence diagram, with upper events occurring before than lower events. In event 400, the group B clients 348 log into the main host 304 and begin communicating with the roaming communication system 300. The group A clients 328 also log into the main host 304 in event 402. In event 404A, one of the group A clients 328 contacts the main host 304 to request connection to one of the group B clients 348. In event 404B, the main host 304 connects the group A client 328 with the appropriate group B client 348. Events 406A and 406B illustrate an example of the main host 304 broadcasting system information to each of the group A clients 328 and the group B clients 348. This is accomplished by the main host 304 sending one copy of the system information to each of the group B clients 348 in event 406A and sending one copy of the system information to each of the group A clients 328 in event 406B. Please note that since the group A and group B remote hosts 326 and 346 have not yet been added to the roaming communication system 300, the main host 304 communicates directly with the group A clients 328 and the group B clients 348.

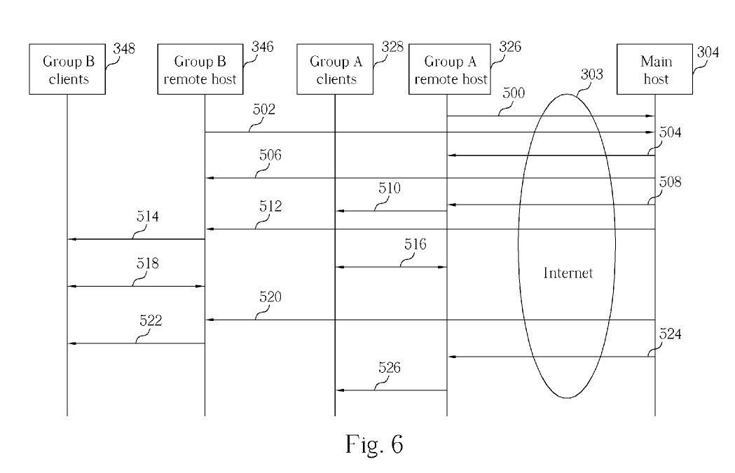

Please refer to FIG. 6. FIG. 6 is a message sequence diagram showing initialization of the roaming communication system 300 after insertion of the group A and group B remote hosts 326 and 346. The group A and group B remote hosts 326 and 346 are inserted to perform bandwidth control and advance switching functions for group A 301 and group B 302. All requests by the group A and group B clients 328 and 348 are routed to the main host 304 by the group A and group B remote hosts 326 and 346. Conversely, all commands given by the main host 304 to the group A and group B clients 328 and 348 are relayed by the group A and group B remote hosts 326 and 346. In events 500 and 502, the group A and group B remote hosts 326 and 346 log into the main host 304, respectively. In events 504 and 506, the main host 304 collects group information from the group A and group B remote hosts 326 and 346 about their respective clients. This information includes virtual IP (VIP) and media access control (MAC) address information. In events 508 and 512, the main host 304 sends system information to the group A and group B remote hosts 326 and 346, respectively. In this case, and in each case below when the main host 304 sends information to the group A and group B remote hosts 326 and 346, only one copy is sent to each remote host 326 and 346. The remote hosts 326 and 346 will then send a duplicate copy of the information to each of their respective clients.

In events 510 and 514, the group A and group B remote hosts 326 and 346 pass the system information on to the group A and group B clients 328 and 348, and request attention from the clients. In events 516 and 518, the group A and group B clients 328 and 348 report to the group A and group B remote hosts 326 and 346 configure themselves to report to the group A and group B remote hosts 326 and 346 instead of the main host 304. In events 520 and 524, the main host 304 sends system information to the group A and group B remote hosts 326 and 346. In events 522 and 526, the group A and group B remote hosts 326 and 346 send duplicate copies to the group A and group B clients 328 and 348. Please note that the events shown in FIG. 6 are used as an example only, and are not limiting of the present invention. It will be appreciated that many of the separate events described above can be combined together, to minimize the amount of handshaking needed between the various components of the roaming communication system 300.

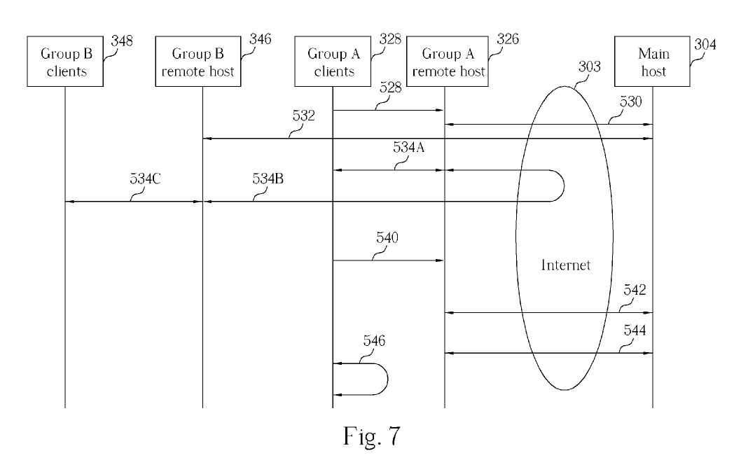

FIG. 6 shows the initialization of the group A and group B remote hosts 326 and 346 and the group A and group B clients 328 and 348 with the main host 304. Please refer to FIG. 7. FIG. 7 is a message sequence diagram showing communication in the roaming communication system 300 after initialization. In event 528, one of the group A clients 328, which is a source client, attempts to communicate with one of the group B clients 348, which is a destination client. To initiate communication, the group A client 328 sends a request to the group A remote host 326 in event 528. The group A remote host 326 then contacts the main host 304 in event 530 to request a connection between the source group A client 328 and the destination group B client 348. Next, the main host 304 contacts the group B remote host 346 in event 532. The source group A client 328 then begins communicating with the destination group B client 348 through a string data flow. This flow is illustrated by events 534A, 534B, and 534C, in which the source group A client 328 communicates with the group A remote host 326, the group A remote host 326 communicates with the group B remote host 346 via the Internet 303, and the group B remote host 346 communicates with the destination group B client 348. Please note that the group A and group B remote hosts 326 and 346 can communicate directly through the Internet 303 without using the main host 304 as an intermediary. This is because each of the group A and group B remote hosts 326 and 346 has already communicated with the main host 304, and has received authorization for communication to take place between the source group A client 328 and the destination group B client 348. Alternatively, the group A and group B remote hosts 326 and 346 can also communicate with each other using the main host 304 as an intermediary.

Events 540-546 show another example of communication in the roaming communication system 300. In this example, a source group A client 328 attempts to communicate with a destination group A client 328. In event 540, the source group A client 328 sends a request to the group A remote host 326. The group A remote host 326 then sends the request to the main host 304 in event 542. The main host 304 grants this request in event 544. Then, the source group A client 328 then begins communicating with the destination group A client 328 through a string data flow in event 546. Because both the source and destination clients are both in group A 301, the source group A client 328 and the destination group A client 328 communicate locally in a local area network (LAN) without needing to send the data through the group A remote host 326 first. Of course, the source group A client 328 and the destination group A client 328 can also communicate with each other by using the group A remote host 326 as an intermediary.

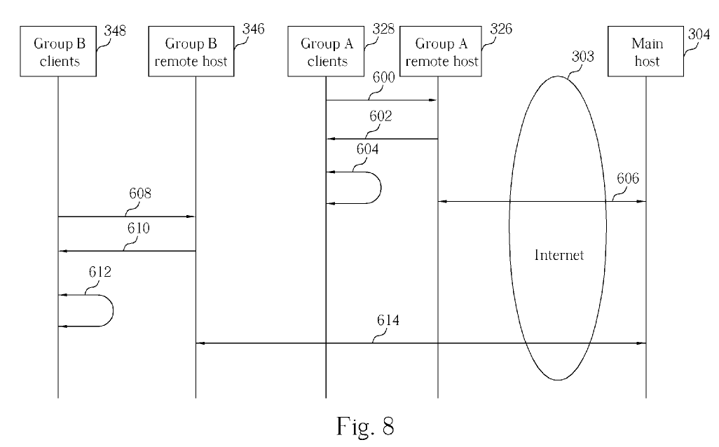

FIGS. 6 and 7 showed communication in the roaming communication system 300 when the main host 304 was connected to the group A and group B remote hosts 326 and 346. Please refer to FIG. 8. FIG. 8 is a message sequence diagram showing communication in the roaming communication system 300 after the main host 304 is disconnected from the group A and group B remote hosts 326 and 346. If one or more of the group A and group B remote hosts 326 and 346 becomes disconnected from the main host 304, communication within group A 301 or within group B 302 can still take place. For example, suppose that a source group A client 328 attempts to communicate with a destination group A client 328. Since the group A remote host 326 is already aware that connection with the main host 304 is disrupted, the group A remote host 326 will not send a connection request to the main host 304. Therefore, when the source group A client 328 sends a request to the group A remote host 326 in event 600, the group A remote host 326 responds by sending a request to the destination group A client 328 in event 602. Thereafter, the source group A client 328 and the destination group A client 328 begin communicating locally through a string data flow in event 604. Although the group A remote host 326 is still able to facilitate communication within group A 301, the group A remote host 326 keeps trying to contact the main host 304 in event 606 to see if the connection to the main host 304 is reestablished.

If group B 302 also becomes disconnected from the main host 304, the group B remote host 346 is also able to facilitate communication within group B 302. That is, when the source group B client 348 sends a request to the group B remote host 346 in event 608, the group B remote host 346 responds by sending a request to the destination group B client 348 in event 610. Thereafter, the source group B client 348 and the destination group B client 348 begin communicating locally through a string data flow in event 612. The group B remote host 346 keeps trying to contact the main host 304 in event 614 to see if the connection to the main host 304 is reestablished. Therefore, if either or both of the group A and group B remote hosts 326 and 346 are disconnected from the main host 304 (due to disruptions in Internet connections, for example), group A 301 and group B 302 can still operate as a local PBX/KTS and as a LAN. Once the group A and group B remote hosts 326 and 346 are reconnected to the main host 304, the roaming communication system 300 will operate normally once again.

In contrast to the prior art, the present invention roaming communication system contains remote hosts in remote telephone groups for controlling data transmitted within the roaming communication system. The remote host acts as a group executioner for commands given by the main host. If the main host needs to send data or messages to all of the IP-based telephones in the telecommunications network, the main host only has to send the data or messages to the remote host. The remote host will then send a copy of the data or messages to each of the IP-based telephones in the same group as the remote host. In addition, the remote host can act as a host for the corresponding group of IP-based telephones if the group ever becomes disconnected from the main host. In this way, the IP-based telephones can still be used to send calls locally within the group when the main host cannot be contacted.

Those skilled in the art will readily observe that numerous modifications and alterations of the device may be made while retaining the teachings of the invention. Accordingly, the above disclosure should be construed as limited only by the metes and bounds of the appended claims.

1. A method of routing data between IP-based telephone extensions in a telecommunications network, the method comprising:
providing a first remote telephone group containing a first set of IP-based telephones and a second remote telephone group containing a second set of IP-based telephones, the first and second remote telephone groups being connected to the Internet through first and second IP sharing devices, respectively;
connecting a main host to the Internet for controlling data traffic over the Internet between the first remote telephone group and the second remote telephone group;
connecting a remote host to the Internet through the first IP sharing device for linking the first remote telephone group to the second remote telephone group and main host;
the remote host connecting with and logging into the main host;
generating data packets with a source IP-based telephone in the first remote telephone group for contacting a destination IP-based telephone in the second remote telephone group;
transmitting the data packets to the remote host;
the remote host transmitting the data packets to the main host; and
the main host transmitting the data packets to the destination IP-based telephone in the second remote telephone group for establishing communication between the source IP-based telephone in the first remote telephone group and the destination IP-based telephone in the second remote telephone group.

2. The method of claim 1 further comprising:
generating data packets with a source IP-based telephone in the second remote telephone group for contacting a destination IP-based telephone in the first remote telephone group;
transmitting the data packets to the main host;
the main host transmitting the data packets to the remote host; and
the remote host transmitting the data packets to the destination IP-based telephone in the first remote telephone group for establishing communication between the source IP-based telephone in the second remote telephone group and the destination IP-based telephone in the first remote telephone group.

3. The method of claim 1 further comprising:
generating data packets with a source IP-based telephone in the first remote telephone group for contacting a destination IP-based telephone in the first remote telephone group;
the remote host contacting the main host to request connection of the source IP-based telephone and the destination IP-based telephone;
the main host contacting the remote host to grant connection of the source IP-based telephone and the destination IP-based telephone;
the remote host establishing a direct connection between the source IP-based telephone and the destination IP-based telephone; and
the source IP-based telephone communicating with the destination IP-based telephone.

4. The method of claim 3 wherein the source IP-based telephone communicates with the destination IP-based telephone locally without connecting to the Internet.

5. The method of claim 1 further comprising:
terminating connection between the remote host and the main host;
generating data packets with a source IP-based telephone in the first remote telephone group for contacting a destination IP-based telephone in the first remote telephone group;
the remote host establishing a direct connection between the source IP-based telephone and the destination IP-based telephone; and
the source IP-based telephone communicating with the destination IP-based telephone.

6. The method of claim 5 wherein the source IP-based telephone communicates with the destination IP-based telephone locally without connecting to the Internet.

7. The method of claim 1 wherein the remote host performs bandwidth control functions for the first remote telephone group.

8. The method of claim 1 wherein the remote host sends duplicate copies of system information received from the main host to each of the IP-based telephones in the first remote telephone group.

9. The method of claim 1 wherein the first and second IP sharing devices each share a connection to a dynamic IP address.

10. A method of routing data between IP-based telephone extensions in a telecommunications network, the method comprising:
providing first remote telephone group containing a first set of IP-based telephones and a second remote telephone group containing a second set of IP-based telephones, the first and second remote telephone groups being connected to the Internet through first and second IP sharing devices, respectively;
connecting a main host to the Internet for controlling data traffic over the Internet between the first remote telephone group and the second remote telephone group;
connecting a first remote host to the Internet through the first IP sharing device for linking the first remote telephone group to the second remote telephone group and main host;
connecting a second remote host to the Internet through the second IP sharing device for linking the second remote telephone group to the first remote telephone group and main host;
the first and second remote hosts connecting with and logging into the main host;
generating data packets with a source IP-based telephone in the first remote telephone group for contacting a destination IP-based telephone in the second remote telephone group;
transmitting the data packets to the first remote host;
the first remote host transmitting the data packets to the second remote host; and
the second remote host transmitting the data packets to the destination IP-based telephone in the second remote telephone group for establishing communication between the source IP-based telephone in the first remote telephone group and the destination IP-based telephone in the second remote telephone group.

11. The method of claim 10 further comprising:
generating data packets with a source IP-based telephone in the second remote telephone group for contacting a destination IP-based telephone in the first remote telephone group;
transmitting the data packets to the second remote host;
the second remote host transmitting the data packets to the first remote host; and
the first remote host transmitting the data packets to the destination IP-based telephone in the first remote telephone group for establishing communication between the source IP-based telephone in the second remote telephone group and the destination IP-based telephone in the first remote telephone group.

12. The method of claim 10 further comprising:
generating data packets with a source IP-based telephone in the first remote telephone group for contacting a destination IP-based telephone in the first remote telephone group;
the first remote host contacting the main host to request connection of the source IP-based telephone and the destination IP-based telephone;
the main host contacting the first remote host to grant connection of the source IP-based telephone and the destination IP-based telephone;
the first remote host establishing a direct connection between the source IP-based telephone and the destination IP-based telephone; and
the source IP-based telephone communicating with the destination IP-based telephone.

13. The method of claim 12 wherein the source IP-based telephone communicates with the destination IP-based telephone locally without connecting to the Internet.

14. The method of claim 10 further comprising:
terminating connection between the first remote host and the main host;
generating data packets with a source IP-based telephone in the first remote telephone group for contacting a destination IP-based telephone in the first remote telephone group;
the first remote host establishing a direct connection between the source IP-based telephone and the destination IP-based telephone; and
the source IP-based telephone communicating with the destination IP-based telephone.

15. The method of claim 14 wherein the source IP-based telephone communicates with the destination IP-based telephone locally without connecting to the Internet.

16. The method of claim 10 wherein the first and second remote hosts perform bandwidth control functions for the first and second remote telephone groups, respectively.

17. The method of claim 10 wherein the first and second remote hosts send duplicate copies of system information received from the main host to each of the IP-based telephones in the first and second remote telephone groups, respectively.

18. The method of claim 10 wherein the first and second IP sharing devices each share a connection to a dynamic IP address.
